(19) United States
(12) Patent Application Publication
(10) Pub. No.: US 2024/0204531 A1
(43) Pub. Date: Jun. 20, 2024

(54) SINGLE-CONTROLLABLE LOW VOLTAGE MICROGRID, CONTROL PROCESS AND USE

(71) Applicants: PETROLEO BRASILEIRO S.A. - PETROBRAS, Rio de Janciro (BR); UNIVERSIDADE FEDERAL DE MINAS GERAIS, Belo Horizonte (BR)

(72) Inventors: Danilo Iglesias BRANDÃO, Belo Horizonte (BR); Geovane Luciano Dos Reis, Belo Horizinte (BR)

(21) Appl. No.: 18/543,496

(22) Filed: Dec. 18, 2023

(30) Foreign Application Priority Data
Dec. 19, 2022 (BR) BR 1020220258953

(51) Int. Cl. H02J 3/38; H02J 3/18; H02J 3/32

(52) U.S. Cl. CPC H02J 3/381; H02J 3/18; H02J 3/32; H02J 3/388; H02J 2203/10; H02J 2300/24

(57) ABSTRACT

This technology refers to a control process for single-controllable low-voltage microgrids (Mgs) (SCM) having centralized communication. The process is based on the “Power-Based Control” (PBC) technique by adapting it to the context of SCMs through a modified PBC process (MPBC). The technology includes a process that provides the following technical effects: (1) sharing of active power and reactive power proportionately to the capacity of distributed energy resources (DERs or DGs) in the MG, for example, rendering the use of batteries based on different technologies (lead-acid, ion-lithium, etc.) compatible; (2) compensation for the current unbalance at the point of common coupling (PAC); (3) allows exploration of battery banks by balancing the charging status of storage elements; (4) allows implementation of the control process without knowing the electrical grid's parameters and topology; (5) is able to deal with the arbitrary connection of inverters into the MG, in addition to other advantages. The technology is applied in the technical field of equipment and infrastructure for the development of MGs.

The instant technology refers to a control process for single-controllable low-voltage microgrids (MGs) (SCM) having centralized communication. The process is based on the “Power-Based Control” (PBC) technique by adapting it to the context of SCMs through a modified PBC process (MPBC). The technology includes a process that provides the following technical effects: (1) sharing of active power and reactive power proportionately to the capacity of distributed energy resources (DERs or DGs) in the MG, for example, rendering the use of batteries based on different technologies (lead-acid, ion-lithium, etc.) compatible; (2) compensation for the current unbalance at the point of common coupling (PAC); (3) allows exploration of battery banks by balancing the charging status of storage elements; (4) allows implementation of the control process without knowing the electrical grid's parameters and topology; (5) is able to deal with the arbitrary connection of inverters into the MG, in addition to other advantages. The technology is applied in the technical field of equipment and infrastructure for the development of MGs.

The PBC secondary control strategy offers a simple implementation that provides for the sharing of active and reactive power proportionally to the capabilities of existing DERs, in addition to controlling the power flow in the grid and compensating for unbalance in the PAC, without the need for prior knowledge of the grid parameters or the combination of other techniques, through a simple algebraic formulation (T. Caldognetto, S. Buso, P. Tenti, and D. I. Brandao, “,” IEEE J. Emerg. Sel. Topics Power Electron., vol. 3, no. 4, pp. 1056-1066, December 2015).

There is no technology available in the state of the art that resembles the invention as proposed in the present patent application, which provides a control process for single-controllable low voltage microgrids (MGs) (SCM) and provides the following technical effects: (1) sharing of active power and reactive power proportionately to the capacity of distributed energy resources (DERs or DGs) in the MG, for example, rendering the use of batteries based on different technologies (lead-acid, ion-lithium, etc.) compatible; (2) compensation for the current unbalance at the point of common coupling (PAC); (3) allows exploration of battery banks by balancing the charging status of storage elements; (4) allows implementation of the control process without knowing the electrical grid's model and topology; (5) is able to deal with the arbitrary connection of inverters into the MG.

The “Energy Time Shift” (ETS) service is aimed at storing energy in batteries when its cost is low and supplying this energy when costs are high during the period of the day where the demand is the highest, between 5 pm and 8 pm, which is when the delivered electric energy has a better selling price. This approach maximizes profits and reduces the payback time for system investments. Moreover, to supply full capacity energy, which is a desirable characteristic in the context of the ETS service, it is essential for the battery banks to supply energy to meet the full demand proportionately to their individual capacities, since if a bank reaches its minimum state of charge (SOC) it may cause interruption of the ETS service and power imbalance relative to the main grid. Therefore, the technology proposed in the patent application, designated herein as MPBC, allows execution of the ETS service as it has means of exploring the battery banks by balancing the state of charge of energy storage elements.

The MPBC process proposed herein does not require detailed information on the MG (for example, line impedances or topology), and unlike many approaches, the MPBC process does not require primary control details (for example, details of the converter dynamics, current control, Phase-Locked Loop (PLL), and so on), which usually render the formulation more complex.

Thus, the MPBC simply requires the exchange of information between the central controller (CC) located at the secondary control layer and the layer of the primary controller (where the DERs are located) and tertiary controller (where the distribution system operator is located (DSO).

### DETAILED DESCRIPTION OF THE TECHNOLOGY

This technology refers to a control process for single-controllable low-voltage microgrids (Mgs) (SCM) having centralized communication. The process is based on the “Power-Based Control” (PBC) technique by adapting it to the context of SCMs through a modified PBC process (MPBC). The technology includes a process that provides the following technical effects: (1) sharing of active power and reactive power proportionately to the capacity of distributed energy resources (DERs or DGs) in the MG, for example, rendering the use of batteries based on different technologies (lead-acid, ion- lithium, etc.) compatible; (2) compensation for the current unbalance at the point of common coupling (PAC); (3) allows exploration of battery banks by balancing the charging status of storage elements; (4) allows implementation of the control process without knowing the electrical grid's model and topology; (5) is able to deal with the arbitrary connection of inverters into the MG.

The single-controllable microgrid structure is formed by circuit breakers and contactors for connecting elements and for switching between islanded- or grid connected-operating modes, charges, distributed energy resources (DERs) equipped with battery banks, photovoltaic panels; a bus for connecting critical charges during MG operation in islanded mode; a central controller responsible for managing the MG in the islanded and connected modes of operation, which is responsible for the proportional sharing of active and reactive power between the DERs to meet the power references in the PCC with the main grid in connected mode and optimization of the DERs to meet the MG's requirement in islanded mode.

The control process for single-controllable low-voltage microgrids (Mgs) includes the following steps:
a) temporally delimiting a control cycle k;
b) measuring for the control cycle k the status of each DERₘₙ, where index mn represents the connections between phases in the three-phase system a, b and c (mn=ab,bc,ca) and j is a numeric identifier for each DER in the MG. Such status is represented by: (i) P_{DER}_{ⱼₘₙ} (k), Q_{DER}_{ⱼₘₙ} (k), output active and reactive power, respectively; (ii) actual maximum capacity to provide active power P_{DER}_{ⱼₘₙ}^{max}(k), actual maximum capacity to absorb active power P_{DER}_{ⱼₘₙ}^{min} (k), expressed as a negative value; (iii) maximum capacity of processing reactive power Qmax_{DER}_{ⱼₘₙ}^{max} as calculated by expression (1), where A_{DER}_{ⱼₘₙ} (k) is the DER apparent power:

$${Q}_{{DERj}_{mn}}^{max} ( k ) = \sqrt{{{A}_{{DERj}_{mn}} ( k )}^{2} - {{P}_{{DERj}_{mn}} ( k )}^{2}} ; \qquad ( 1 )$$

c) once the CC located at the secondary level has gathered all the necessary data packets from each DER of the MG, status of the MG is calculated in terms of power quantities. The first step calculates the total amounts of power and energy E_{DER}_{ⱼₘₙ}(k) stored in the battery banks of DERs connected between mn phases according to expression (2):

$$[ {P}_{{DERt}_{mn}} , {Q}_{{DERt}_{mn}} , {P}_{{DERt}_{mn}}^{max} , {Q}_{{DERt}_{mn}}^{max} , {E}_{{DERt}_{mn}} ] = {\sum }_{j = 1}^{J} [ {P}_{{DERj}_{mn}} , {Q}_{{DERj}_{mn}} , {P}_{{DERj}_{mn}}^{max} , {Q}_{{DERj}_{mn}}^{max} , {E}_{{DERj}_{mn}} ] ; \qquad ( 2 )$$

d) converting the power computed per phase in the PCC (P_{PCC}_{ₐ}, P_{PCC}_{_{b}} and P_{PCC}_{_{c}}) by the central controller due to power star measurement between phases (P_{PCC}_{_{ab}}, P_{PCCD}_{_{c}} and P_{PCC}_{_{ca}}) using the conversion matrix (A) using expression (3) and analogously converting the reactive powers using expression (4), where P_{PCC}_{ₘ} and Q_{PCC}_{ₘ} are the active and reactive powers, respectively, as measured in m phase on the grid side at PCC:

$$[ \begin{matrix}{P}_{{PCC}_{ab}} \\ {P}_{{PCC}_{bc}} \\ {P}_{{PCC}_{ca}}\end{matrix} ] = {\underbrace{[ \begin{matrix}1 & 1 & - 1 \\ - 1 & 1 & 1 \\ 1 & - 1 & 1\end{matrix} ]}}_{A} \cdot [ \begin{matrix}{P}_{{PCC}_{a}} \\ {P}_{{PCC}_{b}} \\ {P}_{{PCC}_{c}}\end{matrix} ] \qquad ( 3 )$$

$$[ \begin{matrix}{Q}_{{PCC}_{ab}} \\ {Q}_{{PCC}_{bc}} \\ {Q}_{{PCC}_{ca}}\end{matrix} ] = {\underbrace{[ \begin{matrix}1 & 1 & - 1 \\ - 1 & 1 & 1 \\ 1 & - 1 & 1\end{matrix} ]}}_{A} \cdot [ \begin{matrix}{Q}_{{PCC}_{a}} \\ {Q}_{{PCC}_{b}} \\ {Q}_{{PCC}_{c}}\end{matrix} ] ; \qquad ( 4 )$$

e) determining for control cycle k the active (P_{LT}_{ₘₙ}(k)) to reactive (Q_{LT}_{ₘₙ}(k)) power balance between MG phases (i.e., the sum of charges plus losses equals generation) using expressions 5 to 10:

$${P}_{{Lt}_{ab}} ( k ) = {P}_{{PCC}_{a}} ( k ) + {P}_{{PCC}_{b}} ( k ) - {P}_{{PCC}_{c}} ( k ) + {P}_{{DERt}_{ab}} ( k ) \qquad ( 5 )$$

$${P}_{{Lt}_{bc}} ( k ) = - {P}_{{PCC}_{a}} ( k ) + {P}_{{PCC}_{b}} ( k ) + {P}_{{PCC}_{c}} ( k ) + {P}_{{DERt}_{bc}} ( k ) \qquad ( 6 )$$

$${P}_{{Lt}_{ca}} ( k ) = {P}_{{PCC}_{a}} ( k ) - {P}_{{PCC}_{b}} ( k ) + {P}_{{PCC}_{c}} ( k ) + {P}_{{DERt}_{ca}} ( k ) \qquad ( 7 )$$

$${Q}_{{Lt}_{ab}} ( k ) = {Q}_{{PCC}_{a}} ( k ) + {Q}_{{PCC}_{b}} ( k ) - {Q}_{{PCC}_{c}} ( k ) + {Q}_{{DERt}_{ab}} ( k ) \qquad ( 8 )$$

$${Q}_{{Lt}_{bc}} ( k ) = - {Q}_{{PCC}_{a}} ( k ) + {Q}_{{PCC}_{b}} ( k ) + {Q}_{{PCC}_{c}} ( k ) + {Q}_{{DERt}_{bc}} ( k ) \qquad ( 9 )$$

$${Q}_{{Lt}_{ca}} ( k ) = {Q}_{{PCC}_{a}} ( k ) - {Q}_{{PCC}_{b}} ( k ) + {Q}_{{PCC}_{c}} ( k ) + {Q}_{{DERt}_{ca}} ( k ) ; \qquad ( 10 )$$

f) by knowing the power balance, the CC calculates the active and reactive power references (P_{DER}_{ₜₘₙ}^{*}(k+1), Q_{DERt}_{ₘₙ}* (k+1)) to be provided by the MG DERs in the next control time cycle (k+1) using expressions 11 to 16, where P_{PCC}_{ₘ}^{*}(k+1) and Q_{PCC}_{ₘ}^{*}(k+1) are, respectively, the active and reactive power references associated with the power flow per phase in the PCC, being defined by the tertiary controller layer:

$$( 11 )$$

$${P}_{{DERt}_{ab}}^{*} ( k + 1 ) = {P}_{{Lt}_{ab}} ( k ) - {P}_{{PCC}_{a}}^{*} ( k + 1 ) - {P}_{{PCC}_{b}}^{*} ( k + 1 ) + {P}_{{PCC}_{c}}^{*} ( k + 1 )$$

$$( 12 )$$

$${P}_{{DERt}_{bc}}^{*} ( k + 1 ) = {P}_{{Lt}_{bc}} ( k ) + {P}_{{PCC}_{a}}^{*} ( k + 1 ) - {P}_{{PCC}_{b}}^{*} ( k + 1 ) - {P}_{{PCC}_{c}}^{*} ( k + 1 )$$

$$( 13 )$$

$${P}_{{DERt}_{ca}}^{*} ( k + 1 ) = {P}_{{Lt}_{ca}} ( k ) - {P}_{{PCC}_{a}}^{*} ( k + 1 ) + {P}_{{PCC}_{b}}^{*} ( k + 1 ) - {P}_{{PCC}_{c}}^{*} ( k + 1 )$$

$$( 14 )$$

$${Q}_{{DERt}_{ab}}^{*} ( k + 1 ) = {Q}_{{Lt}_{ab}} ( k ) - {Q}_{{PCC}_{a}}^{*} ( k + 1 ) - {Q}_{{PCC}_{b}}^{*} ( k + 1 ) + {Q}_{{PCC}_{c}}^{*} ( k + 1 )$$

$$( 15 )$$

$${Q}_{{DERt}_{bc}}^{*} ( k + 1 ) = {Q}_{{Lt}_{bc}} ( k ) + {Q}_{{PCC}_{a}}^{*} ( k + 1 ) - {Q}_{{PCC}_{b}}^{*} ( k + 1 ) - {Q}_{{PCC}_{c}}^{*} ( k + 1 )$$

$$( 16 )$$

$${Q}_{{DERt}_{ca}}^{*} ( k + 1 ) = {Q}_{{Lt}_{ca}} ( k ) - {Q}_{{PCC}_{a}}^{*} ( k + 1 ) + {Q}_{{PCC}_{b}}^{*} ( k + 1 ) - {Q}_{{PCC}_{c}}^{*} ( k + 1 ) ;$$

g) the CC calculates the scalar coefficients for the J^{th} DERs connected between the “mn” α_{P}_{ₘₙ} α_{Q}_{ₘₙ} phases (all varying within the range [−1, 1]). The active power is controlled by coefficient αₚ, while the reactive power is controlled by coefficient α_{Q}. Scalar coefficients are calculated according to expressions 17 to 20, being dependent P_{DER}_{ₜ}^{*} and Q_{DERt}^{*} as compared to the maximum (P_{DERt}^{max}) and minimum (P_{PERt}^{min}) values. Sign α_{P}_{ₘₙ} indicates active power injection when positive and or active power storage when negative, while sign α_{Q}_{ₘₙ} indicates capacitive reactive power injection (if negative) or inductive reactive absorption (if positive). After calculating α_{P}_{ₘₙ} and α_{Q}_{ₘₙ}, they are transmitted to all DERs:

$$If {P}_{{DERt}_{mn}}^{*} ( k + 1 ) < {P}_{{DERt}_{mn}}^{min} ( k ) then {α}_{{P}_{mn}} = - 1 \qquad ( 17 )$$

$$( 18 )$$

$$If {P}_{{DERt}_{mn}}^{min} ( k ) \leq {P}_{{DERt}_{mn}}^{*} ( k + 1 ) \leq {P}_{{DERt}_{mn}}^{max} ( k ) then {α}_{{P}_{mn}} = \frac{{P}_{{DERt}_{mn}}^{*} ( k + 1 )}{{P}_{{DERt}_{mn}}^{max} ( k )}$$

$$If {P}_{{DERt}_{mn}}^{*} > {P}_{{DERt}_{mn}}^{max} ( k ) then {α}_{{P}_{mn}} = 1 \qquad ( 19 )$$

$$If {P}_{{DERt}_{mn}}^{*} > {P}_{{DERt}_{mn}}^{max} ( k ) then {α}_{{P}_{mn}} = 1 ; \qquad ( 20 )$$

h) if the MG is provided with different battery banks in terms of aging and/or technology, then power sharing cannot only be proportional to the power capacity of the DERs, but must also consider usable power. Therefore, it is necessary to maintain equalization of the usable power between all battery banks dispersed in the MG, in order to reach their maximum and minimum SOC values at approximately the same instant of time. Therefore, the scalar coefficients are weighted in terms of usable power to ensure maximum usage of the battery banks. From the usable power of each bank, the CC calculates the average power according to expression 21 and then applies expression 22 to weight the scalar coefficients to be sent to the respective DERs:

$${E}_{avg} ( k ) = \frac{{E}_{{DERt}_{ab}} ( k ) + {E}_{{DERt}_{bc}} ( k ) + {E}_{{DERt}_{ca}} ( k )}{J ( k )} \qquad ( 21 )$$

$$Se {P}_{{DERt}_{mn}}^{min} ( k ) \leq {P}_{{DERt}_{mn}}^{*} ( k + 1 ) \leq {P}_{{DERt}_{mn}}^{max} ( k ) \qquad ( 22 )$$

$$Then {α}_{{P}_{mn}} = \frac{{P}_{{DERt}_{mn}}^{*} ( k + 1 )}{{P}_{{DERt}_{mn}}^{max} ( k )} \cdot \frac{{E}_{{DERt}_{mn}} ( k )}{{E}_{avg} ( k )} ;$$

i) after the DERs receive the scalar coefficients sent by the CC, they calculate their individual active and reactive power references to be used in their internal control loops (i.e. primary controller layer) according to their individual maximum power capacity. Table 1 is used to obtain the power references defined in the local control of the DERs for different values of scalar coefficients:

TABLE 1
Power references implemented in the local control of DERs.

| Scalar coefficients | Power reference for the DER |
|---|---|
| α_{Pmn} = −1 | P*_{DERj}_{ₘₙ} = P_{DERj}_{ₘₙ}^{min} |
| −1 < α_{Pmn} ≤ 0 | P*_{DERj}_{ₘₙ} = α_{P}_{ₘₙ} · P_{DERj}_{ₘₙ}^{min} |
| 0 < α_{Pmn} < 1 | P*_{DERj}_{ₘₙ} = α_{P}_{ₘₙ} · P_{DERj}_{ₘₙ}^{max} |
| α_{Pmn} = 1 | P*_{DERj}_{ₘₙ} = P_{DERj}_{ₘₙ}^{max} |
| −1 ≤ α_{Qmn} ≤ 1 | Q*_{DERj}_{ₘₙ} = α_{Q}_{ₘₙ} · Q_{DERj}_{ₘₙ}^{max} |

The present invention can be better understood through the following non-limiting examples.

### Example 1-Exemplary Implementation of the Technology

A single-controllable three-phase four-wire MG was implemented, comprising: a programmable 4-quadrant 30 kVA source from the ACS, which is responsible for forming the grid during islanded operation of the MG; contactors and circuit breakers responsible for switching between islanded or grid connected operating modes; circuit breakers and contactors to disconnect non-critical charges in islanded mode; photovoltaic plant with a 12 kW three-phase inverter from PHB, model PHB12KN-DT; programmable 12 kVA, 4 quadrant charge, of model NHR 9430; a specific bus for connecting critical charges; three SMA Sunny Island 6.0H inverters provided with three different 5 kW and 15 kWh battery banks of usable power: lead-acid (48V -1320 Ah), six sets in parallel composed of four batteries (12MS234 from Moura); lithium-ion (48V -500 Ah), five modules in parallel (UPLFP48 from Unipower); sodium-nickel (48V -400 Ah), two modules in parallel (48TL200 from FZSONICK). The SMA DERs with their respective banks were connected in the delta configuration due to their nominal operating voltage. The MG was coordinated through a central controller (CC) implemented on the Raspberry Pi B3₊minicomputer. The Power node device is responsible for measuring electrical quantities in the MG PCC and is in star configuration. The Power node measures voltages and currents in the MG PCC and calculates the active and reactive powers, transferring them to the central controller (CC) through a ModBus RTU communication link (RS-485). It further disconnects non-critical charges (by activating contactors) during operation of the MG in islanded mode. CC interoperability with SMA DERs is based on communication via ModBus TCP. The proposed MPBC algorithm was implemented by using the “Node-RED” programming tool, embedded on the Pi B3₊Raspberry.

In the microgrid implemented and controlled by the MPBC, the following performance characteristics were obtained:
1) Communication latency was limited by the time required to update the SMA DERs parameters via ModBus TCP communication, which in practice resulted in a time of 45 seconds. For stable operation, the interval used in the CC instance to define a control cycle required an update interval of 60 seconds in practice.
2) The “Energy Time Shift” (ETS) service was implemented in the MG between 5 pm and 8 pm, the three battery banks with different technologies were able to supply 5 kW power to the MG uninterruptedly during the period of greatest demand.

To restore the reactive power setpoint values, the latency found in the microgrid implemented and controlled by the MPBC was 40 to 45 seconds, which is explained by the inherent limitation in the inverter update time.

Mitigation of power unbalance in the MG PCC by the MPBC was assessed in light of the experimental instance where an unbalanced resistive charge of: 0.5 kW, 1 kW and 1.5 kW is connected to a, b and c phases, respectively. At 200 s, the MPBC is activated, and the PCC power is controlled in P_{P}_{_{cc}}*=1 kW. Then, the PCC power reference changes to zero (at 680 s), to 0.5 kW at 860 s and to zero again at 1100 s, always providing balanced power to the main grid. Finally, at 1380 s, the MPBC is disabled, resulting again in power imbalance at the PCC.

1. A control process for a single-controllable low voltage microgrid characterized in that it comprises the following steps:
a) temporally delimiting a control cycle k;
b) measuring for control cycle k found in step “a” the status of each DERₘₙ, where index mn represents the connections between phases in the three-phase system a, b and c (mn=ab,bc,ca) and j is a numeric identifier for each DER in the MG, wherein such status is represented by: (i) P_{DER}_{ⱼₘₙ}(k), Q_{DER}_{ⱼₘₙ}(k), output active and reactive power, respectively; (ii) actual maximum capacity to provide active power P_{DER}_{ⱼₘₙ}^{max}(k), actual maximum capacity to absorb active power P_{DER}_{ⱼₘₙ}^{min}(k), expressed as a negative value; (iii) maximum capacity of processing reactive power Q_{DER}_{ⱼₘₙ}^{max} as calculated by expression (1), where A_{DER}_{ⱼₘₙ}(k) is the DER apparent power:
$${Q}_{{DERj}_{mn}}^{max} ( k ) = \sqrt{{{A}_{{DERj}_{mn}} ( k )}^{2} - {{P}_{{DERj}_{mn}} ( k )}^{2}} ; \qquad ( 1 )$$
c) once the CC located at the secondary level has gathered all the required data packets from each DER in the MG, calculating the status of the MG in terms of power quantities, with the first step calculating the total power and energy E_{DER}_{ⱼₘₙ}(k) quantities stored in DER battery banks connected between the mn phases using expression (2):
$$[ {P}_{{DERt}_{mn}} , {Q}_{{DERt}_{mn}} , {P}_{{DERt}_{mn}}^{max} , {Q}_{{DERt}_{mn}}^{max} , {E}_{{DERt}_{mn}} ] = {\sum }_{j = 1}^{J} [ {P}_{{DERj}_{mn}} , {Q}_{{DERj}_{mn}} , {P}_{{DERj}_{mn}}^{max} , {Q}_{{DERj}_{mn}}^{max} , {E}_{{DERj}_{mn}} ] ; \qquad ( 2 )$$
d) converting the power computed per phase in the PCC (P_{PCC}_{ₐ}, P_{PCC}_{_{b}} and P_{PCC}_{_{c}}) by the central controller due to power star measurement between phases (P_{PCC}_{_{ab}}, P_{PCC}_{_{bc}} and P_{PCC}_{_{ca}}) using conversion matrix (A) using expression (3) and analogously converting the reactive powers using expression (4), where P_{PCC}_{ₘ} and Q_{PCC}_{ₘ} are the active and reactive powers, respectively, as measured in m phase on the grid side at the PCC:
$$[ \begin{matrix}{P}_{{PCC}_{ab}} \\ {P}_{{PCC}_{bc}} \\ {P}_{{PCC}_{ca}}\end{matrix} ] = {\underbrace{[ \begin{matrix}1 & 1 & - 1 \\ - 1 & 1 & 1 \\ 1 & - 1 & 1\end{matrix} ]}}_{A} \cdot [ \begin{matrix}{P}_{{PCC}_{a}} \\ {P}_{{PCC}_{b}} \\ {P}_{{PCC}_{c}}\end{matrix} ] \qquad ( 3 )$$
$$[ \begin{matrix}{Q}_{{PCC}_{ab}} \\ {Q}_{{PCC}_{bc}} \\ {Q}_{{PCC}_{ca}}\end{matrix} ] = {\underbrace{[ \begin{matrix}1 & 1 & - 1 \\ - 1 & 1 & 1 \\ 1 & - 1 & 1\end{matrix} ]}}_{A} \cdot [ \begin{matrix}{Q}_{{PCC}_{a}} \\ {Q}_{{PCC}_{b}} \\ {Q}_{{PCC}_{c}}\end{matrix} ] ; \qquad ( 4 )$$
e) determining for control cycle k the active (P_{Lt}_{ₘₙ}(k)) to reactive (Q_{Lt}_{ₘₙ}(k)) power balance between MG phases i.e., the sum of charges plus losses equals generation, expressions 5 to 10:
$${P}_{{Lt}_{ab}} ( k ) = {P}_{{PCC}_{a}} ( k ) + {P}_{{PCC}_{b}} ( k ) - {P}_{{PCC}_{c}} ( k ) + {P}_{{DERt}_{ab}} ( k ) \qquad ( 5 )$$
$${P}_{{Lt}_{bc}} ( k ) = - {P}_{{PCC}_{a}} ( k ) + {P}_{{PCC}_{b}} ( k ) + {P}_{{PCC}_{c}} ( k ) + {P}_{{DERt}_{bc}} ( k ) \qquad ( 6 )$$
$${P}_{{Lt}_{ca}} ( k ) = {P}_{{PCC}_{a}} ( k ) - {P}_{{PCC}_{b}} ( k ) + {P}_{{PCC}_{c}} ( k ) + {P}_{{DERt}_{ca}} ( k ) \qquad ( 7 )$$
$${Q}_{{Lt}_{ab}} ( k ) = {Q}_{{PCC}_{a}} ( k ) + {Q}_{{PCC}_{b}} ( k ) - {Q}_{{PCC}_{c}} ( k ) + {Q}_{{DERt}_{ab}} ( k ) \qquad ( 8 )$$
$${Q}_{{Lt}_{bc}} ( k ) = - {Q}_{{PCC}_{a}} ( k ) + {Q}_{{PCC}_{b}} ( k ) + {Q}_{{PCC}_{c}} ( k ) + {Q}_{{DERt}_{bc}} ( k ) \qquad ( 9 )$$
$${Q}_{{Lt}_{ca}} ( k ) = {Q}_{{PCC}_{a}} ( k ) - {Q}_{{PCC}_{b}} ( k ) + {Q}_{{PCC}_{c}} ( k ) + {Q}_{{DERt}_{ca}} ( k ) ; \qquad ( 10 )$$
f) by knowing the power balance, the CC calculates the active and reactive power references (P_{DERt}_{ₘₙ}^{*}(k+1), Q_{DERt}_{ₘₙ}^{*}(k+1)) to be provided by the MG DERs in the next control time cycle (k+1) using expressions 11 to 16, where P_{PCC}_{ₘ}^{*}(k+1) and Q_{PCC}_{ₘ}^{*}(k+1) are, respectively, the active and reactive power references associated with the power flow per phase in the PCC, being defined by the tertiary controller layer:
$$( 11 )$$
$${P}_{{DERt}_{ab}}^{*} ( k + 1 ) = {P}_{{Lt}_{ab}} ( k ) - {P}_{{PCC}_{a}}^{*} ( k + 1 ) - {P}_{{PCC}_{b}}^{*} ( k + 1 ) + {P}_{{PCC}_{c}}^{*} ( k + 1 )$$
$$( 12 )$$
$${P}_{{DERt}_{bc}}^{*} ( k + 1 ) = {P}_{{Lt}_{bc}} ( k ) + {P}_{{PCC}_{a}}^{*} ( k + 1 ) - {P}_{{PCC}_{b}}^{*} ( k + 1 ) - {P}_{{PCC}_{c}}^{*} ( k + 1 )$$
$$( 13 )$$
$${P}_{{DERt}_{ca}}^{*} ( k + 1 ) = {P}_{{Lt}_{ca}} ( k ) - {P}_{{PCC}_{a}}^{*} ( k + 1 ) + {P}_{{PCC}_{b}}^{*} ( k + 1 ) - {P}_{{PCC}_{c}}^{*} ( k + 1 )$$
$$( 14 )$$
$${Q}_{{DERt}_{ab}}^{*} ( k + 1 ) = {Q}_{{Lt}_{ab}} ( k ) - {Q}_{{PCC}_{a}}^{*} ( k + 1 ) - {Q}_{{PCC}_{b}}^{*} ( k + 1 ) + {Q}_{{PCC}_{c}}^{*} ( k + 1 )$$
$$( 15 )$$
$${Q}_{{DERt}_{bc}}^{*} ( k + 1 ) = {Q}_{{Lt}_{bc}} ( k ) + {Q}_{{PCC}_{a}}^{*} ( k + 1 ) - {Q}_{{PCC}_{b}}^{*} ( k + 1 ) - {Q}_{{PCC}_{c}}^{*} ( k + 1 )$$
$$( 16 )$$
$${Q}_{{DERt}_{ca}}^{*} ( k + 1 ) = {Q}_{{Lt}_{ca}} ( k ) - {Q}_{{PCC}_{a}}^{*} ( k + 1 ) + {Q}_{{PCC}_{b}}^{*} ( k + 1 ) - {Q}_{{PCC}_{c}}^{*} ( k + 1 ) ;$$
g) the CC calculates the scalar coefficients for the Jth DERs connected between the “mn” α_{P}_{ₘₙ} and α_{Q}_{ₘₙ} phases (all varying withing the range of [−1, 1]), wherein the active power is controlled by coefficient αₚ, while the reactive power is controlled by coefficient α_{Q}, o; the scalar coefficients are calculated using expressions 17 to 20, being dependent on P_{DERt}^{*} and Q_{DERt}^{*} as compared to the maximum (P_{DERt}^{max}) and minimum (P_{DERt}^{min}) values; sign α_{P}_{ₘₙ} indicates active power injection when positive and or active power storage when negative, while sign aoindicates injection of capacitive reactive power (if negative) or absorption of inductive reactive power (if positive), and after calculating α_{P}_{ₘₙ} and α_{Q}_{ₘₙ}, they are transmitted to all DERs:
$$If {P}_{{DERt}_{mn}}^{*} ( k + 1 ) < {P}_{{DERt}_{mn}}^{min} ( k ) then {α}_{{P}_{mn}} = - 1 \qquad ( 17 )$$
$$( 18 )$$
$$If {P}_{{DERt}_{mn}}^{min} ( k ) \leq {P}_{{DERt}_{mn}}^{*} ( k + 1 ) \leq {P}_{{DERt}_{mn}}^{max} ( k ) then {α}_{{P}_{mn}} = \frac{{P}_{{DERt}_{mn}}^{*} ( k + 1 )}{{P}_{{DERt}_{mn}}^{max} ( k )}$$
$$If {P}_{{DERt}_{mn}}^{*} > {P}_{{DERt}_{mn}}^{max} ( k ) then {α}_{{P}_{mn}} = 1 \qquad ( 19 )$$
$$If {P}_{{DERt}_{mn}}^{*} > {P}_{{DERt}_{mn}}^{max} ( k ) then {α}_{{P}_{mn}} = 1 ; \qquad ( 20 )$$
h) if the MG is provided with different battery banks in terms of aging and/or technology, then energy sharing cannot only be proportional to the energy capacity of the DERs, but must also consider the usable energy, thus, it is necessary maintain equalization of usable energy between all battery banks dispersed in the MG in order to reach their maximum and minimum SOC values at approximately the same instant of time, and thus the scalar coefficients are weighted in terms of usable energy to ensure maximum usage of the battery banks based on the usable capacity of each bank, the CC calculates the average energy using expression 21 and then applies expression 22 to weight the scalar coefficients to be sent to the respective DERs:
$${E}_{avg} ( k ) = \frac{{E}_{{DERt}_{ab}} ( k ) + {E}_{{DERt}_{bc}} ( k ) + {E}_{{DERt}_{ca}} ( k )}{J ( k )} \qquad ( 21 )$$
$$Se {P}_{{DERt}_{mn}}^{min} ( k ) \leq {P}_{{DERt}_{mn}}^{*} ( k + 1 ) \leq {P}_{{DERt}_{mn}}^{max} ( k ) \qquad ( 22 )$$
$$Then {α}_{{P}_{mn}} = \frac{{P}_{{DERt}_{mn}}^{*} ( k + 1 )}{{P}_{{DERt}_{mn}}^{max} ( k )} \cdot \frac{{E}_{{DERt}_{mn}} ( k )}{{E}_{avg} ( k )} ;$$
i) after the DERs receive the scalar coefficients sent by the CC, they calculate their individual active and reactive power references to be used in their internal control loops, i.e. The primary controller layer, according to their individual maximum power capacity, and Table 1 is used to obtain power references defined in DER local controller for different values of scalar coefficients:
TABLE 1
Power references implemented in the DER local controller

| Scalar coefficients | Power reference for the DER |
|---|---|
| α_{Pmn} = −1 | P*_{DERj}_{ₘₙ} = P_{DERj}_{ₘₙ}^{min} |
| −1 < α_{Pmn} ≤ 0 | P*_{DERj}_{ₘₙ} = α_{P}_{ₘₙ} · P_{DERj}_{ₘₙ}^{min} |
| 0 < α_{Pmn} < 1 | P*_{DERj}_{ₘₙ} = α_{P}_{ₘₙ} · P_{DERj}_{ₘₙ}^{max} |
| α_{Pmn} = 1 | P*_{DERj}_{ₘₙ} = P_{DERj}_{ₘₙ}^{max} |
| −1 ≤ α_{Qmn} ≤ 1 | Q*_{DERj}_{ₘₙ} = α_{Q}_{ₘₙ} · Q_{DERj}_{ₘₙ}^{max} |

2. A single-controllable low voltage microgrid, characterized in that it is controlled by the process as defined in claim 1 and comprises switches for connecting elements and for switching between islanded or grid connected modes of operation, charges, distributed energy resources (DERs), such as batteries/battery banks, photovoltaic panels, the DERs having inverters for a connection interface within the MG, an AC bus (for example, for connection of critical charges during islanded mode operation of the MG), a central controller to allow sharing of supply of active and reactive power between the DERs, to control the active and reactive power exchanged with the main grid and to control the switching between islanded and main grid-connected modes.

3. The single-controllable low voltage microgrid according to claim 2, characterized in that it is implemented by the following technical elements and their interrelations: a programmable 4-quadrant 30 kVA source from ACS that is responsible for forming the grid during islanded operation of the MG, contactors and circuit breakers responsible for switching between islanded or grid-connected operation modes; circuit breakers and contactors to disconnect non-critical charges in islanded mode, photovoltaic plant with a 12 kW three-phase inverter from PHB, model PHB12KN-DT, a programmable 12 kVA 4-quadrant charge of model NHR 9430, a specific bus for connecting critical charges, three inverters provided with provided with three different battery banks of 5 kW and 15 kWh of usable energy: lead-acid (48V -1320 Ah), six sets in parallel composed of four batteries, lithium-ion (48V -500 Ah), five modules in parallel, sodium-nickel (48V -400 Ah), two modules in parallel, the SMA DERs with their respective banks being connected in delta configuration due to their nominal operating voltage, the MG being coordinated through a central controller (CC) implemented in a minicomputer, the power node device being responsible for measuring electrical quantities in the MG PCC and being in star configuration, wherein the power node measures voltages and currents at the MG PCC and calculates active and reactive powers, transferring them to the central controller (CC) through a ModBus RTU (RS-485) communication link, also performing shutdowns of non-critical charges by activating contactors during operation of the MG in islanded mode, wherein the interoperability of the CC with the SMA DERs is based on communication via ModBus TCP, the proposed MPBC algorithm being implemented using the “Node-RED” programming tool embedded in the minicomputer.

4. Use of the control process for single-controllable low voltage microgrids as defined in claim 1, characterized in that it is to control a single-controllable low voltage microgrid.

5. Use of the control process for single-controllable low voltage microgrids as defined in claim 4, characterized in that it is to control a single-controllable low voltage microgrid as defined in any one of claims 2 and 3.
